(19) United States
(12) Patent Application Publication
(10) Pub. No.: US 2009/0043409 A1
(43) Pub. Date: Feb. 12, 2009

(54) EQUIPMENT CONTROL APPARATUS, CONTROL METHOD, AND CONTROL PROGRAM

(75) Inventor: Shunji Ota, Kasugai-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/186,984

(22) Filed: Aug. 6, 2008

(30) Foreign Application Priority Data
Aug. 9, 2007 (JP) 2007-207865

(51) Int. Cl. G06F 17/00; G01N 1/22; G08B 23/00

(52) U.S. Cl. 700/90; 422/84; 340/576

(57) ABSTRACT

An alcohol density test can be avoided, but the alcohol density test is prevented from being easily avoided at the same time. A vehicle control unit sets a controlled vehicle in a mobile state when an alcohol density detected from the driver is determined to be lower than a predetermined threshold based on results of a test conducted using an alcohol test unit or when an instruction for exemption of the alcohol test is input through an input unit. When an instruction for exemption of the alcohol test is input, a history recording control unit records a history indicating that the alcohol density test has been exempted in a recording unit. The invention may be applied to a vehicle control apparatus for controlling a vehicle based on results of an alcohol density test conducted on the driver.

### BACKGROUND OF THE INVENTION

1. Field of the Invention

The present invention relates to an equipment control apparatus and a method and a program thereof. More particularly, the invention relates to an equipment control apparatus and a method and a program thereof for controlling operations of equipment based on results of an alcohol density test conducted on the operator.

2. Description of the Related Art

One approach to prevention of accidents resulting from drunken-driving proposed in the related art involves the steps of carrying out a compulsory alcohol density test for the breath of a driver before driving (hereinafter also referred to as “alcoholic test”) and disabling the vehicle when the alcohol density is equal to or higher than a predetermined threshold (see Patent Document 1, for example).

Patent Document 1: JP-A-2007-38872

However, when an alcoholic test is carried out on a compulsory basis, starting of a vehicle is delayed by the time required for the alcoholic test in an occasion wherein the vehicle must be started urgently to avoid a danger such as a natural disaster or an accident. In addition, when the alcohol density is miss-detected, the starting of the vehicle is further delayed because test results must be reset and the test must be conducted again. Therefore, it seems desirable to allow an alcoholic test to be avoided in some occasions instead of always obliging the alcoholic test.

On the contrary, when an alcoholic test can be avoided too easily, the effect of preventing drunken-driving cannot be satisfactorily achieved.

The invention was made taking such situations into consideration, and it allows an alcohol density test to be avoided while preventing the alcohol density test from being avoided too easily.

### SUMMARY OF THE INVENTION

An equipment control apparatus in an aspect of the invention includes an operation control unit which inhibits or limits an operation of predetermined equipment until an alcohol density detected from an operator operating the equipment is determined to be lower than a predetermined threshold based on a result of an alcoholic test on the operator or until an instruction for exemption of the alcohol density test is input and which cancels the inhibition or limitation on the operation of the equipment when the alcohol density of the operator is determined to be lower than the predetermined threshold or when the instruction for exemption of the alcohol density test is input and a history recording unit which records the fact that the alcohol density test is exempted.

An operation information recording apparatus in an aspect of the invention records the fact that an operation of predetermined equipment is inhibited or limited until an alcohol density detected from an operator operating the equipment is determined to be lower than a predetermined threshold based on a result of an alcoholic test on the operator or until an instruction for exemption of the alcohol density test is input and the fact that the inhibition or limitation on the operation of the equipment is canceled and the alcohol density test is exempted when the alcohol density of the operator is determined to be lower than the predetermined threshold or when the instruction for exemption of the alcohol density test is input.

Thus, the alcohol density test can be avoided at the operator's will to cancel the inhibition or limitation of the operation of the equipment. At the same time, it is not possible to avoid the alcohol density test easily.

The operation control unit and the history recording unit are constituted by, for example, a CPU (Central Processing Unit).

The history recording unit records at least time when the alcohol density test is exempted.

As a result, the time when the alcohol density test is exempted can be reliably known later.

The operation control unit further cancels the inhibition or limitation on the operation of the equipment regardless of the result of the test when an instruction for invalidation of the test result is input. The history recording unit can further record the fact that the test result is invalidated.

Thus, the result of the alcoholic test can be invalidated at the operator's will to cancel the inhibition or limitation on the operation of the equipment. At the same time, the result of the alcohol density test cannot be easily invalidated.

The history recording unit records at least time when the result of the alcohol density test is invalidated.

As a result, the time when the alcohol density test is invalidated can be reliably known later.

For example, the equipment control apparatus may further include an operation state recording unit which records the state of operation of the equipment after the exemption of the alcohol density test is instructed.

As a result, the state of operation of the operator on the equipment after the alcohol density test is avoided can be known.

The operation state recording unit is constituted by, for example, a CPU (Central Processing Unit).

The equipment control apparatus may further include an image recording unit which records an image including the face of the operator when the exemption of the alcohol density test is instructed.

It is therefore possible to look at the operator who avoided the alcohol density test and to know the state of the operator.

The image recording unit is constituted by, for example, a CPU (Central Processing Unit).

The equipment control apparatus may further include a recognition unit which executes a process of recognizing the operator when the exemption of the alcohol density test is instructed and records the result of recognition.

As a result, the operator who has avoided the alcohol density test can reliably identified.

The recognition unit is constituted by, for example, a CPU (Central Processing Unit).

The equipment control apparatus may further include a reporting unit which transmits information indicating the fact that the alcohol density test is exempted to another apparatus to provide an outgoing report.

As a result, a record of the exemption of the alcoholic test can be reliably left. Information of the fact that the alcohol density test is avoided can be reliably provided to the outside of the apparatus.

For example, the reporting unit may be constituted by a CPU (Central Processing Unit) or various types of communication devices.

An equipment control method or program in an aspect of the invention includes an operation control step for inhibiting or limiting an operation of predetermined equipment until an alcohol density detected from an operator operating the equipment is determined to be lower than a predetermined threshold based on a result of an alcoholic test on the operator or until an instruction for exemption of the alcohol density test is input and canceling the inhibition or limitation on the operation of the equipment when the alcohol density of the operator is determined to be lower than the predetermined threshold or when the instruction for exemption of the alcohol density test is input and a history recording step for recording the fact that the alcohol density test is exempted.

In an equipment control method or program, it is recorded that an operation of predetermined equipment is inhibited or limited until an alcohol density detected from of an operator operating the equipment is determined to be lower than a predetermined threshold based on a result of an alcoholic test on the operator or until an instruction for exemption of the alcohol density test is input, and it is recorded that the inhibition or limitation on the operation of the equipment is canceled and the alcohol density test is exempted when the alcohol density of the operator is determined to be lower than the predetermined threshold or when the instruction for exemption of the alcohol density test is input.

Thus, the alcohol density test can be avoided at the operator's will to cancel the inhibition or limitation of the operation of the equipment. At the same time, it is not possible to avoid the alcohol density test easily.

The operation control step may be an operation control step employing, for example, a CPU to inhibit or limit the operation of the predetermined equipment until the alcohol density of the operator operating the equipment is determined to be lower than the predetermined threshold based on a result of the alcoholic test on the operator or until the instruction for exemption of the alcohol density test is input and to cancel the inhibition or limitation on the operation of equipment when the alcohol density of the operator is determined to be lower than the predetermined threshold or when the instruction for exemption of the alcohol density test is input. The history recording step may be a history recording step employing, for example, a CPU to record the fact that the alcohol density test is exempted.

As described above, in an aspect of the invention, an alcohol density test can be avoided at an operator's will to cancel inhibition or limitation on an operation of equipment. In an aspect of the invention, it is possible to prevent the alcohol density test from being easily avoided.

### BRIEF DESCRIPTION OF THE DRAWINGS

FIG. 1 is a block diagram of an embodiment of a vehicle control system employing the invention;

FIG. 2 is a flow chart for explaining vehicle control processes executed by the vehicle control system;

FIG. 3 is a flow chart for explaining vehicle control processes executed by the vehicle control system; and

FIG. 4 is a block diagram of an example of a configuration of a computer.

### DESCRIPTION OF THE PREFERRED EMBODIMENT

A preferred embodiment of the invention will now be described with reference to the drawings.

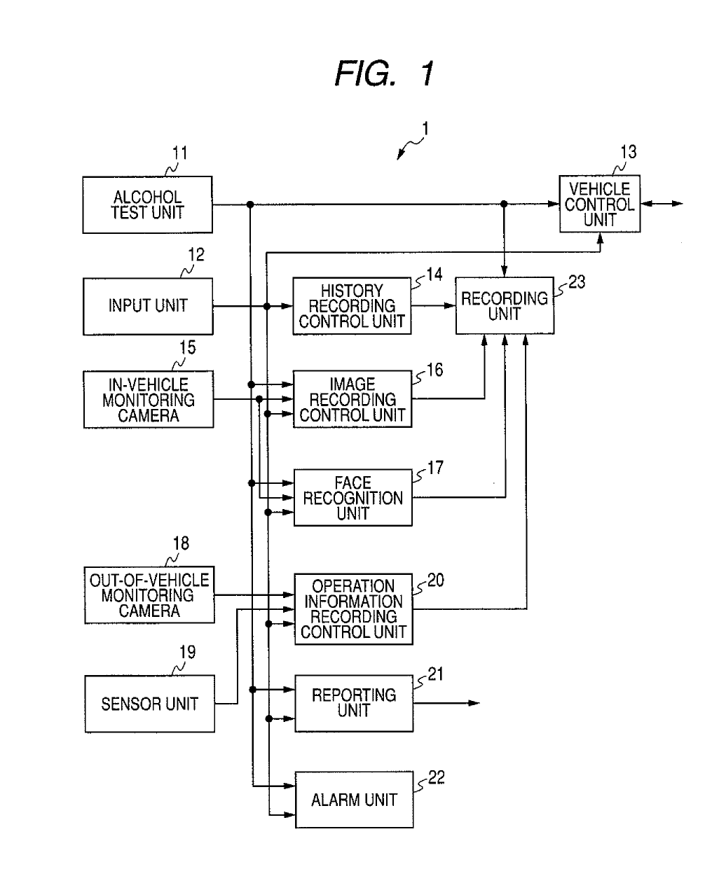

FIG. 1 is a block diagram of an embodiment of a vehicle control system employing the invention. A vehicle control system 1 shown in FIG. 1 is a system for controlling a vehicle on which the vehicle control system 1 is provided (hereinafter also referred to as “controlled vehicle”) based on results of an alcohol test carried out for the driver of the vehicle.

The vehicle control system 1 includes an alcohol test unit 11, an input unit 12, a vehicle control unit 13, a history recording unit 14, an in-vehicle monitoring camera 15, an image recording control unit 16, a face recognition unit 17, an out-of-vehicle monitoring camera 18, a sensor unit 19, an operation information recording control unit 20, a reporting unit 21, and an alarm unit 22.

The alcohol test unit 11 is constituted by, for example, an alcohol sensor which is available on the market. The alcohol test unit 11 detects the alcohol density in the breath of the driver to test whether the detected alcohol density is equal to or higher than a predetermined threshold. The alcohol test unit 11 supplies information indicating the test result to the vehicle control unit 13, the image recording control unit 16, the face recognition unit 17, the reporting unit 21, and the alarm unit 22.

The detection of an alcohol density from the driver carried out by the alcohol test unit 11 is not limited to any particular method. For example, the density of alcohol included in the breath of the driver may be detected, and the density of alcohol included in sweat or blood of the driver may alternatively detected. An alcohol density may be detected through an explicit operation of the driver, and an alcohol density may alternatively be detected in an automatic manner involving no particular operation of the driver.

The input unit 12 is constituted by, for example, buttons, a keyboard, or switches. The driver inputs an instruction to the vehicle control system 1 with the input unit 12. The input unit 12 supplies an instruction thus input to the vehicle control unit 13, the history recording control unit 14, the face recognition unit 17, the operation information recording control unit 20, the reporting unit 21, and the alarm unit 22.

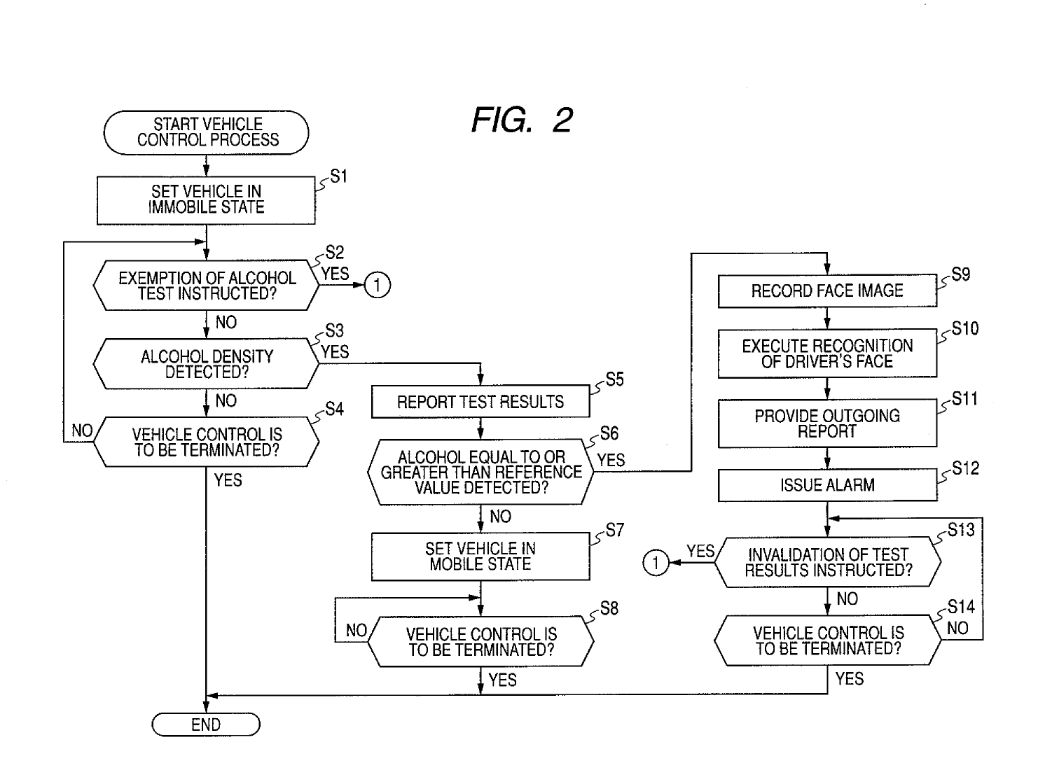

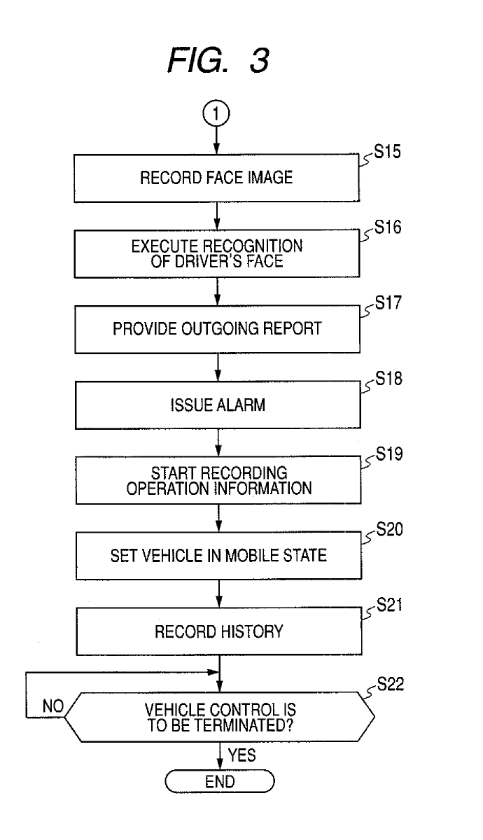

As will be detailed later with reference to FIGS. 2 and 3, the vehicle control unit 13 controls operations of the controlled vehicle based on the result of the alcohol density test carried out on the driver.

As will be detailed later with reference to FIGS. 2 and 3, the history recording control unit 14 records a history indicating that the alcohol density test was exempted (hereinafter also referred to as “exemption history”) and a history indicating that the alcohol density test was invalidated (also referred to as “invalidation history”) in the recording unit 23. The exemption history includes, for example, the time (e.g., the time, day, month, and year) when the alcohol test was exempted. The invalidation history includes, for example, the time (e.g., the time, day, month, and year) when the alcohol test was invalidated.

The in-vehicle monitoring camera 15 is provided in a position where the face of the driver of the controlled vehicle can be photographed. The in-vehicle monitoring camera 15 supplies an image thus photographed including the face of the driver (hereinafter also referred to as “face image”) to the image recording control unit 16 and the face recognition unit 17.

As will be detailed later with reference to FIGS. 2 and 3, the image recording control unit 16 controls the recording of the face image into the recording unit 23.

The face recognition unit 17 executes recognition of the face of the driver included in the face image using a predetermined method. The face recognition unit 17 records information representing the result of recognition in the recording unit 23. The face recognition carried out by the face recognition unit 17 is not limited to any particular method. It is desirable to use a method which allows face recognition to be carried out precisely, quickly, and simply.

The out-of-vehicle monitoring camera 18 is provided, for example, in a position where a view in front of the controlled vehicle can be photographed. The out-of-vehicle monitoring camera 18 supplies an image thus photographed (hereinafter also referred to as “external monitoring image”) to the operation information recording control unit 20.

The sensor unit 19 is constituted by a variety of sensors such as an acceleration sensor, a vehicle speed sensor, a GPS (Global Positioning System) receiver, and a radar device. The unit supplies signals indicating the speed of the controlled vehicle, acceleration, angular acceleration, the amount of an operation of the acceleration pedal, the amount of an operation of the brake pedal, the present position of the controlled vehicle to the operation information recording control unit 20. The sensor unit 19 may be formed by sensors provided in the controlled vehicle, and sensors dedicated to the vehicle control system 1 may alternatively provided.

The operation information recording control unit 20 generates operation information concerning the state of operation of the vehicle based on the external monitoring image from the out-of-vehicle monitoring camera 18 and the signals from the sensor unit 19. The operation information recording control unit 20 records the operation information thus generated in the recording unit 23.

The reporting unit 21 is constituted by, for example, a communication device which performs communication according to a predetermined method of communication. As will be detailed with reference to FIGS. 2 and 3, the reporting unit 21 provides an outgoing report on the fact that alcoholic equal to or higher than a reference value has been detected from the driver, the fact that the alcohol test has been exempted, and the fact that results of the alcohol test have been invalidated.

For example, the alarm unit 22 is constituted by a display device, a light-emitting device such as an LED (Light Emitting Diode) or a lamp, or an alarming device such as a buzzer. The alarm unit 22 provides according to a predetermined method an in-vehicle or outgoing notice of the fact that alcoholic in an amount equal to or greater than a reference value has been detected from the driver, the fact that the alcohol test has been exempted, and the fact that the result of the alcohol test has been invalidated.

The recording unit 23 is constituted by a rewritable non-volatile memory such as a flash memory, an EEPROM (Electrically Erasable and Programmable Read Only Memory), an HDD (Hard Disk Drive), an MRAM (Magnetoresistive Random Access Memory), a FeRAM (Ferroelectric Random Access Memory), or an OUM (Ovonic Unified Memory).

A vehicle control process executed by the vehicle control system 1 will now be described with reference to the flow charts shown in FIGS. 2 and 3. This process is started for example, when a driving motor of the controlled vehicle (e.g., an engine) is started.

At step S1, the vehicle control unit 13 sets the controlled vehicle in an immobile state. For example, the vehicle control unit 13 exercises control such that the driving motor of the controlled vehicle is disabled from rotating. Alternatively, the unit exercises control so as to prevent transmission of the power of the driving motor to the axle to inhibit or limit various parts of the vehicle, thereby setting the controlled vehicle in an immobile state with the driving motor of the controlled vehicle kept active.

At step S2, the vehicle control unit 13 determines whether exemption of the alcohol test has been instructed or not. When the vehicle control unit 13 determines that exemption of the alcohol test has not been instructed, the process proceeds to step S3.

At step S3, the alcohol test unit 11 determines whether an alcohol density has been detected or not. When it is determined that no alcohol density has been detected, the process proceeds to step 54.

At step S4, the vehicle control unit 13 determines whether to terminate the vehicle control or not. When it is determined that the vehicle control is not to be terminate, the process returns to step S2. Then, the processes at steps S2 to S4 are repeated until it is determined at step S2 that exemption of the alcohol test has been instructed or until it is determined at step S3 that the alcohol test has been conducted or until it is determined at step S4 that the vehicle control is to be terminated.

At step S4, the vehicle control unit 13 determines that the vehicle control is to be terminated, for example, when the driving motor of the controlled vehicle is stopped, and the vehicle control process is thus terminated.

At step S3, the driver conducts an alcohol test, for example, using the alcohol test unit 11, and the process proceeds to step S5 when it is determined that an alcohol density was detected by the alcohol test unit 11.

At step S5, the alcohol test unit 11 provides information on the test result. Specifically, the alcohol test unit 11 provides the test result to the vehicle control unit 13, the image recording control unit 16, the face recognition unit 17, the reporting unit 21, and the alarm unit 22 with information indicating the test result. The alcohol test unit 11 also records the test result in the recording unit 23. The test result includes, for example, the time (e.g., the time and date) of the test, the alcohol density detected, and the result of determination of whether the alcohol density is equal to or higher than a predetermined threshold.

At step S6, the vehicle control unit 13 determines whether alcohol in an amount equal to or greater than a reference value has been detected based on the test result from the alcohol test unit 11. When the test result indicates that the alcohol density is lower than the predetermined threshold, the vehicle control unit 13 determines that alcohol in an amount equal to or greater than the reference value has not been detected, and the process proceeds to step S7.

At step S7, the vehicle control unit 13 sets the controlled vehicle in a mobile state. Specifically, the vehicle control unit 13 cancels the inhibition or limitation set on operations of various parts of the controlled vehicle at step S1.

At step S8, it is determined whether to terminate the vehicle control just as the process at step S4. The determination process at step S8 is repeated until it is determined that the vehicle control is to be terminated. The vehicle control process is terminated when it is determined that the vehicle control is to be terminated.

When the test result indicates that the alcohol density is equal to or higher than the predetermined threshold, the vehicle control unit 13 determines that alcohol in an amount equal to or greater than the reference value has been detected at step S6, and the process proceeds to step S9.

At step S9, the image recording control unit 16 records a face image. Specifically, the in-vehicle monitoring camera 15 photographs a part of the driver including the face and supplies the photographed image of the face to the image recording control unit 16 and the face recognition unit 17. The image recording control unit 16 records the photographed face image in the recording unit 23.

At step s10, the face recognition unit 17 executes recognition of the face of the driver. Specifically, the face recognition unit 17 executes a recognition process by recognizing the face of the driver photographed in the face image using a predetermined method, whereby the driver is identified. The face recognition unit 17 records information indicating the result of the recognition in the recording unit 23.

At step S11, the reporting unit 21 provides an outgoing report. The reporting unit 21 transmits information indicating that alcohol in an amount equal to or greater than the reference value has been detected from the driver to a police station or an external server owned by an organization providing drive assistance services using a predetermined communication method. Thus, it is externally reported that alcohol in an amount equal to or greater than the reference value has been detected from the driver, and a record of the information is left outside the vehicle.

At step S22, the alarm unit 22 gives an alarm. Specifically, the alarm unit 22 gives an internal or outgoing report of the fact that alcohol in an amount equal to or greater than the reference value has been detected from the driver by displaying a predetermined message or image, causing the light-emitting device such as an LED to emit light, or issuing an alarm sound.

At step S13, the vehicle control unit 13 determines whether invalidation of the test result has been instructed. When it is determined that invalidation of the test result has not been instructed, the process proceeds to step S14.

At step S14, it is determined whether to terminate the vehicle control just as the process at step S4. When it is determined that the vehicle control is not to be terminated, the process proceeds to step S13. The processes at step S13 and S14 are repeated until it is determined at step S13 that invalidation of the test result has been instructed or until it is determined at step S14 that the vehicle control is to be terminated.

When it is determined at step S14 that the vehicle control is to be terminated, the vehicle control process is terminated.

When it is determined at step S13 that an instruction for invalidation of the test result has been input, the input unit 12 supplies the input instruction to the vehicle control unit 13, the history recording control unit 14, the image recording control unit 16, the face recognition unit 17, the operation information recording control unit 20, the reporting unit 21, and the alarm unit 22. When the instruction for invalidation of the test result is acquired from the input unit 12, the vehicle control unit 13 determines that invalidation of the test result has been instructed, and the process proceeds to step S15.

When an instruction for exemption of the alcohol test is input at step S2, the input unit 12 supplies the input instruction to the vehicle control unit 13, the history recording control unit 14, the image recording control unit 16, the face recognition unit 17, the operation information recording control unit 20, the reporting unit 21, and the alarm unit 22. When the instruction for exemption of the alcohol test is acquired from the input unit 12, the vehicle control unit 13 determines that exemption of the alcohol test has been instructed, and the process proceeds to step S15.

At step S15, a face image is recorded just as the process at step S9. Thereafter, a face image may be periodically recorded until the vehicle control process is terminated.

At step S16, the recognition of the driver's face is executed just as the process at step S10. Thereafter, face recognition may be periodically executed until the vehicle control process is terminated, and the results of recognition may be recorded. It may be determined whether the same person keeps driving based on the recognition results.

At step S17, the reporting unit 21 provides an outgoing report on the fact that the alcohol test has been exempted or the fact that the result of the alcohol test has been invalidated just as the process at step S11.

At step S18, the alarm unit 22 gives an alarm in the same manner as the process at step S12 to provide an internal or outgoing notice of the fact the alcohol test has been exempted or the fact that the result of the alcohol test has been invalidated.

At step S19, the operation information recording control unit 20 starts recording operation information. Specifically, the operation information recording control unit 20 starts generating operation information based on external monitoring images from the out-of-vehicle monitoring camera 18 and signals from the sensor unit 19. The operation information recording control unit 20 also starts recording the operation information thus generated in the recording unit 23.

At step S20, the controlled vehicle is set in a mobile state in the same manner as the process at step S7. Specifically, when exemption of the alcohol test has been instructed, the execution of the alcohol test is avoided, and the controlled vehicle is put in a mobile state. When invalidation of the test result has been instructed, the controlled vehicle is put in a mobile state regardless of the result of the alcohol test.

At step S21, the history recording control unit 14 records history. Specifically, the history recording control unit 14 records the history of exemption of the alcohol density test (exemption history) or the history of invalidation of the result of the alcohol density test (invalidation history) in the recording unit 23.

At step S22, it is determined whether to terminate the vehicle control in the same manner as the process at step S4. The determination process at step S22 is repeated until it is determined that the vehicle control is to be terminated. The vehicle control process is terminated when it is determined that the vehicle control is to be terminated.

As thus described, the alcohol test can be avoided or the result of the alcohol test can be invalidated at the driver's will. Therefore, the vehicle can be started quickly, for example, at the time of emergency. Further, a driver who has no habit of taking alcohol can avoid the alcohol test at the driver's will, for example, to avoid annoyance.

On the other hand, the history of avoidance of the alcohol test or invalidation of the test result made at the driver's will is reliably recorded. Therefore, the driver cannot avoid the alcohol test or invalidate the test result easily due to the effect of psychological restraint.

More detailed information such as a face image of the driver, the result of recognition of the face, and operation information may be recorded or externally reported or issued as an alarm in addition to the exemption history or invalidation history. As a result, the likelihood of dissuading a drunken driver from exemption of the alcohol test or invalidation of test results can be increased except in situations where the vehicle must be urgently moved for good reason when driving is disabled due to an erroneous operation of the alcohol test unit 11 in spite of the fact that the driver is not intoxicated.

When more detailed information is recorded as thus described, in the case of an accident, information concerning the accident can be closely examined based on the information thus recorded.

An image of the face of a driver, the result of recognition of the same, and operation information may be included in exemption history and invalidation history.

When another person takes over the wheel, the takeover may be detected by using seat sensors or face recognition or detecting opening and closing of vehicle doors. Whether a driver changeover has occurred or not may be recorded in the exemption history or invalidation history.

Further, the exemption history or invalidation history may include information concerning the state of use of the vehicle prior to an operation of inputting an instruction for exemption of the alcohol test or an operation of inputting an instruction for invalidation of test results.

The exemption history or invalidation history may alternatively include images of fellow passengers and results of recognition of them.

Further, the exemption history may include the alcohol density in the air of the compartment detected by the alcohol test unit 11 when the driver does not receive the alcohol test.

The above description has addressed an example in which an alcohol test is conducted after the driving motor of a vehicle is started. For example, the alcohol test may alternatively be conducted before the driving motor of the vehicle is started. In this case, for example, a setting is made such that the driving motor can be started when the alcohol density detected from the driver is lower than the predetermined threshold, when exemption of the alcohol test is instructed, or when invalidation of test results is instructed.

It is not essential that the alcohol test unit 11 determines whether an alcohol density is equal to or lower than the predetermined threshold. Such a determination may alternatively be made by, for example, the vehicle control unit 13 based on an alcohol density detected by the alcohol test unit 11.

It is desirable to allow an instruction for exemption of the alcohol test and an instruction for invalidation of test results to be quickly input using a method of input which results in less operational errors. Greater importance may be attached to prevention of easy input of an instruction by obliging a driver to input a password or the like at some sacrifice of the speed of operation.

When a driver attempts to avoid an alcohol test, the driver may be intoxicated. Therefore, it is desirable that the vehicle control system 1 operates to cope with a drunken driver such that the driver will give up driving.

A possible approach is to dissuade a driver from driving by showing a message saying, for example, “The alcohol test can be avoided by pressing an “avoid” button” (for instructing exemption of the alcohol test), but an image photographed on the driver is recorded and the vehicle management center is notified of the fact that the alcohol test has been avoided.”

An alternative approach is to request a driver to perform an operation requiring quickness as a condition to be satisfied to input an instruction for exemption of the alcohol test. For example, a lamp may be blinked after a message saying “Press the avoid button at the moment when the lamp blinks” is output. Then, the exemption of the alcohol test is dispermitted when the avoid button is pressed before the lamp turns on or after a predetermined time passes since the blink of the lamp. Alternatively, a driver may be requested to solve a calculation or problem having an answer which cannot be reached unless the driver is in a normal condition. Then, the exemption of the alcohol test is dispermitted when the answer is not given within a predetermined time. Such approaches prevent a driver from avoiding the alcohol test when the diver is in a dangerous condition to drive and is slow in reactions as a result of drinking.

An alcohol density may be automatically detected from a driver and recorded in cases such as traffic accidents instead of detecting it only through the alcohol test.

A particular person may be designated as a permitter in advance, and a program for a permitting operation may be installed in a portable apparatus such as a cellular phone owned by the permitter. Then, control may be exercised such that exemption of the alcohol test or invalidation of test results is carried out after it is confirmed that a permitting operation has been performed by the permitter by activating the program.

Further, a unit for detecting abnormality of the alcohol test unit 11 may be provided, and control may be exercised to allow exemption of the alcohol test when abnormality of the alcohol test unit 11 is detected.

When the alcohol test unit 11 is configured to detect an alcohol density from the breath of a driver, a rule may be made to disallow a driver to avoid the alcohol test when the alcohol test unit 11 detects alcohol in the excess of a predetermined density without the act of the driver of breathing against the alcohol test unit 11.

Drivers of emergency vehicles such as ambulances frequently encounter situations in which they must start the emergency vehicles urgently. It is not practical to avoid the alcohol test and to take the consequent steps of recording a face image and operation information, providing an outgoing report, and issuing internal and outgoing alarms in each of such situations.

Under the circumstance, drivers authorized to avoid the alcohol test such as drivers of emergency vehicles may be registered in advance such that they can be authenticated using living body authentication based on fingerprints, palm prints, faces, or retinal patterns or authentication devices such as ID cards and ID tags. Then, a driver is allowed to avoid the alcohol test without any special operation and to skip the steps of recording a face image and operation information, providing an outgoing report, and issuing internal and outgoing alarms only when the driver is identified to be a person authorized to avoid the alcohol test. The above-described process shown in FIG. 2 may be executed when the driver is not identified to be a person authorized to avoid the alcohol test, e.g., when an unregistered driver is going to drive an emergency vehicle to move it for purposes such as inspection and repair.

In such a case, it is desirable to ensure that a driver of an emergency vehicle receives the alcohol test before riding on the vehicle by, for example, making it a rule to conduct an alcohol check which is carried out by a manager or the like on a face-to-face basis before the driver engages in the job or when the driver is on standby.

In addition to drivers of emergency vehicles as described above, people who may be registered as drivers authorized to avoid the alcohol test include, for example, drivers who cannot drink because they are unable to dissolve alcohol for reasons associated with their predisposition.

The above description has addressed an embodiment of the invention which is on an assumption that an automobile is to be controlled. However, the invention may be applied to situations wherein a mandatory alcohol test is carried out before driving or operating a vehicle other than an automobile, e.g., a train, ship, or airplane. The invention may be also applied to situations wherein a mandatory alcohol test is carried out before operating a machine other than a vehicle, e.g., a machine for operating a crane.

In the case of such a vehicle or machine to be controlled, for example, an operation of the same is inhibited or limited until an alcohol density detected from the operator is determined to be lower than a predetermined threshold or until an instruction for exemption of an alcohol density test is input or until an instruction for invalidation of test results is input. The inhibition or limitation on the operation is cancelled when the alcohol density detected from the operator is determined to be lower than a predetermined threshold or when the instruction for exemption of an alcohol density test is input or when the instruction for invalidation of test results is input. Depending on the alcohol density detected from the operator, the type of the operation to be inhibited or limited or the degree of the limitation placed on the operation may be changed.

The above-described series of processes of the vehicle control system 1 may be implemented on either hardware or software basis. When the series of processes of the vehicle control system 1 is implemented on a software basis, a program constituting the software is installed from a program recording medium to a computer which is incorporated in dedicated hardware or a general-purpose personal computer which is enabled for execution of various functions by installing various programs therein.

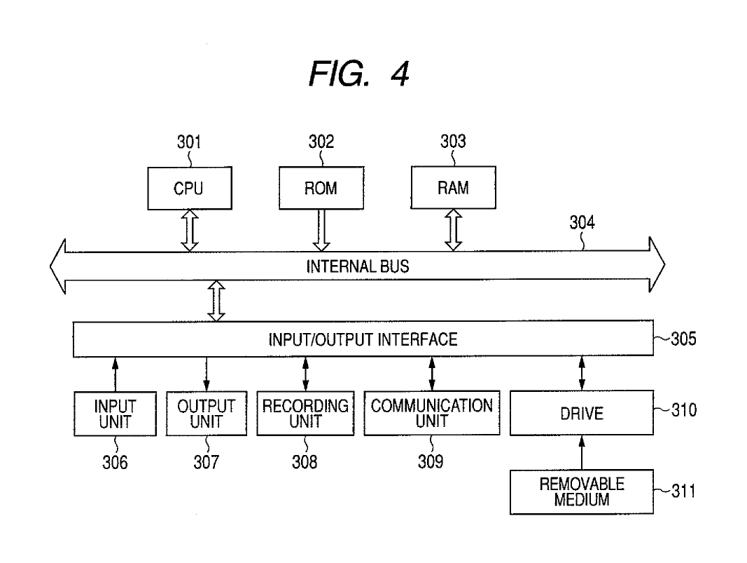

FIG. 4 is a block diagram showing an example of a hardware configuration of a computer for executing the above-described series of processes of the vehicle control system 1 according to a program.

In the computer, a CPU (Central Processing Unit) 301, a ROM (Read Only Memory) 302, and a RAM (Random Access Memory) 303 are connected to each other through a bus 304.

An input/output interface 305 is also connected to the bus 304. The input/output interface 305 is also connected with an input unit 306 including the function of the input unit 12 of the vehicle control system 1, an output unit 307 including the function of the alarm unit 22, a recording unit 308 including the function of the recording unit 23, a communication unit 309 constituted by a network interface and including part of the function of the reporting unit 21, and a drive 310 for driving a removable medium 311 such as a magnetic disk, an optical disk, a magnetooptical disk, or a semiconductor memory.

In the computer having the above-described configuration, for example, a program recorded in the recording unit 308 is loaded to the RAM 303 through the input/output interface 305 and the bus 304 and executed to perform the above-described series of processes.

The program executed by the computer (CPU 301) is provided by recording it in the removable medium 311 which is a package medium constituted by, for example, a magnetic disk (which may be a flexible disk), an optical disk (CD-ROM (Compact Disk-Read Only Memory), a DVD (Digital Versatile Disk or the like), a magnetooptical disk, or a semiconductor memory. The program is alternatively provided through a wired or wireless transmission medium such as a local area network, internet, or a digital satellite broadcast.

The program may be installed in the recording unit 308 through the input/output interface 305 by mounting the removable medium 311 in the drive 310. The program may alternatively be installed in the recording unit 308 by receiving it by the communication unit 309 through a wired or wireless transmission medium. Alternatively, the program may be installed in advance in the ROM 302 or the recording unit 308.

The program executed by the computer may be a program for executing the processes on a time-sequential basis in the order described in this specification. Alternatively, it may be a program for executing the processes in parallel or at timing when the processes are required, e.g., when the program is called.

In this specification, the term “system” means an apparatus as a whole constituted by a plurality of subordinate apparatus and units.

The implementation of the invention is not limited to the above-described embodiment, and various modifications may be made without departing from the spirit of the invention.

What is claimed is:

1. An equipment control apparatus comprising:
an operation control unit which inhibits or limits an operation of predetermined equipment until an alcohol density detected from an operator operating the equipment is determined to be lower than a predetermined threshold based on a result of an alcoholic test on the operator or until an instruction for exemption of the alcohol density test is input and which cancels the inhibition or limitation on the operation of the equipment when the alcohol density of the operator is determined to be lower than the predetermined threshold or when the instruction for exemption of the alcohol density test is input; and
a history recording unit which records the fact that the alcohol density test is exempted.

2. The equipment control apparatus according to claim 1, wherein the history recording unit records at least the time when the alcohol density test is exempted.

3. The equipment control apparatus according to claim 1, wherein the operation control unit cancels the inhibition or limitation on the operation of the equipment regardless of the result of the test when the instruction of invalidation of the test result is input; and
the history recording unit records the fact that the test result is invalidated.

4. The equipment control apparatus according to claim 3, wherein the history recording unit records at least the time when the test result is invalidated.

5. The equipment control apparatus according to claim 1, further comprising an operation state recording unit which records the state of operation of the equipment after exemption of the alcohol density test is instructed.

6. The equipment control apparatus according to claim 1, further comprising an image recording unit which records an image including the face of the operator when exemption of the alcohol density test is instructed.

7. The equipment control apparatus according to claim 1, further comprising a recognition unit which executes a process of recognizing the operator when exemption of the alcohol density test is instructed and records the result of recognition.

8. The equipment control apparatus according to claim 1, further comprising a reporting unit which provides an outgoing report by transmitting information indicating the fact that he alcohol density test is exempted to another apparatus.

9. An equipment control method comprising:
an operation control step for inhibiting or limiting an operation of predetermined equipment until an alcohol density detected from an operator operating the equipment is determined to be lower than a predetermined threshold based on a result of an alcoholic test on the operator or until an instruction for exemption of the alcohol density test is input and canceling the inhibition or limitation on the operation of the equipment when the alcohol density of the operator is determined to be lower than the predetermined threshold or when the instruction for exemption of the alcohol density test is input; and
a history recording step for recording the fact that the alcohol density test is exempted.

10. A program for causing a computer to execute a process comprising:
an operation control step for inhibiting or limiting an operation of predetermined equipment until an alcohol density detected from an operator operating the equipment is determined to be lower than a predetermined threshold based on a result of an alcoholic test on the operator or until an instruction for exemption of the alcohol density test is input and canceling the inhibition or limitation on the operation of the equipment when the alcohol density of the operator is determined to be lower than the predetermined threshold or when the instruction for exemption of the alcohol density test is input; and
a history recording step for recording the fact that the alcohol density test is exempted.
